(19) United States
(12) Patent Application Publication
(10) Pub. No.: US 2009/0194728 A1
(43) Pub. Date: Aug. 6, 2009

(54) Wide-Body Pneumatic Valve having Internalized Valve Actuator

(76) Inventors: Evan Pickett, Medford, OR (US); Randy Regennitter, Yreka, CA (US); Sean Casarotti, Yreka, CA (US); Thomas Deany, Yreka, CA (US)

Correspondence Address: Karl M. Steins;Steins & Associates, Suite 120, 2333 Camino del Rio South, San Diego, CA, 92108, US

(21) Appl. No.: 12/365,547

(22) Filed: Feb. 4, 2009

Related U.S. Application Data
(60) Provisional application No. 61/063,806, filed on Feb. 5, 2008.

(51) Int. Cl. F16K 41/10; F16K 1/32

(52) U.S. Cl. 251/335.3; 251/318

(57) ABSTRACT

A Wide-body Valve Having an Internalized Actuator is disclosed. The preferred valve provides exceptional conductance while also providing a compact valve and actuator package. The valve incorporates a geometry wherein the internal diameter of the valve is approximately 180% of the diameter of the valve's port. Furthermore, the stroke of the valve is preferably 30% or more of port diameter. Also, the valve actuator housing is designed to cooperate with the valve body housing such that the actuator housing is encapsulated within the valve body housing such that the valve part count and valve part volume is reduced over conventional valves.

This application is filed within one year of, and claims priority to Provisional Application Ser. No. 61/063,806, filed Feb. 5, 2008.

### BACKGROUND OF THE INVENTION

1. Field of the Invention

This invention relates generally to valves and actuators and, more specifically, to a Wide-body Valve Having an Internalized Actuator.

2. Description of Related Art

Pneumatic (and other remotely-controllable) valves are very prevalent in semiconductor and other high-purity manufacturing and processing equipment. One typical valve is depicted in FIG. 1. FIG. 1 is a perspective view of a conventional pneumatic actuator valve assembly 10. The assembly 10 has two major elements: the valve 14 and the valve actuator assembly 12. The actuator assembly provides the actuation force that opens and closes the valve 14. The valve 14 depicted here is commonly known as a “poppet” valve. The poppet valve is used extensively in all manner of gas lines used in the semiconductor industry. The poppet valve 14 has in inlet port 22 and an outlet port 20, in this case, at right angles to one another. The housing 24 of the actuator assembly 12 conventionally attaches to the top portion of the valve body housing 16 at the body flange 18. As depicted here, the conventional pneumatic actuator valve assembly 10 has an actuator added to the top of the valve. FIG. 2 further clarifies this typical arrangement

FIG. 2 is a cutaway side view of the valve assembly 10. The actuator assembly has a housing 24, within which is an air piston 36, which is forced to travel up and down within the housing 24 by application of gas under pressure. The movement of the air piston 36 drives the valve stem 32 up and down, which in turn causes the valve to open or close. Valves are also available that have solenoid actuators, wherein the depicted pneumatic actuator assembly 12 is exchanged with an actuation mechanism that obtains its force from operation of an electrical solenoid.

The essential moving components within the valve 14 are contained within the valve body housing 16. The valve stem 32 extends between the actuator assembly 12 air piston 36, and the poppet 26. The depicted valve is known as a “bellows” valve because the valve stem 32 is encapsulated within a bellows 31. The bellows 31 creates the opportunity for high level vacuum conditions within the valve body housing 16 while preventing contaminants (such as lubricants, etc.) from transferring from the valve stem 32 or housing 24 and into the interior of the valve body housing 16 (and of course into the process stream). The bellows 31 allows for the extension and contraction of the valve stem.

The side port 20 allows flow into or out of the interior of the valve body 2o housing 16. Fluid flows in or out past the valve seat 30 and into or out through the bottom port 22. The poppet 26 is located at the distal end of the valve stem 32. When the poppet 26 is lifted away from the valve seat 30, the valve 14 is in the “open” position. When the poppet 26 is pressed against the valve seat 30, the poppet seal 28 creates a seal with the valve seat 30, and the valve 14 is in the “closed” position. Many valves use a spring to determine the “home” position of the valve actuator.

A primary performance feature for poppet valves is the “conductance” or speed through which fluid can flow through the valve. In particular, it is typically most beneficial if the valve 14 and associated system can be drawn down into a high vacuum condition very rapidly (thereby removing contained fluid from the valve and piping system). Historically, it has been understood that the theoretical conductance of a particular valve was determined simply by the cross-sectional size of its inlet and outlet ports 20, 22 and a to theoretical minimum amount of separation of the poppet and the poppet seat. There are several formulas that are used to calculate flow in and around objects. This is commonly called Computational Fluid Dynamics (CFD). Each set of formulas in CFD applications is empirically verified to work within a given pressure range. Therefore, the application of these equations in vacuum is at best an approximation, since no formula covers the entire pressure range typically seen by a vacuum valve. The problem is that the approximate solutions based on current readily available CFD programs have resulted in a general design of valves that are not ideally suited to the large pressure range that they operate within. Furthermore, the user base in the industry is constantly striving to make the valve functional components smaller and smaller.

### SUMMARY OF THE INVENTION

In light of the aforementioned problems associated with the prior devices, it is an object of the present invention to provide a Wide-body Valve Having an Internalized Actuator. The valve should provide exceptional conductance while also providing a compact valve and actuator package. It is a further object that the valve incorporate a geometry wherein the internal diameter of the valve is approximately 180% of the diameter of the valve's port. Furthermore, the stroke of the valve should be approximately 30% or greater of the port diameter. A still Her object is that the valve actuator housing be designed to cooperate with the valve body housing such that the actuator housing can be encapsulated within the valve body housing such that the valve part count and valve part volume is reduced over conventional valves.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a conventional pneumatic actuator valve assembly;

FIG. 2 is a cutaway side view of the aforementioned valve assembly shown in FIG. 1;

FIG. 3 is a partially exploded perspective view of a preferred embodiment of the wide-body valve having an internalized actuator of the present invention;

FIG. 4 is a cutaway side view of the device of FIG. 3;

FIG. 5 is a partial cutaway side view of the poppet geometry of the valve of FIGS. 3 and 4; and

FIG. 6 depicts the performance comparison between the conventional valve of FIGS. 1 and 2 with the valve of FIGS. 3-5.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Wide-body Valve Having an Internalized Actuator.

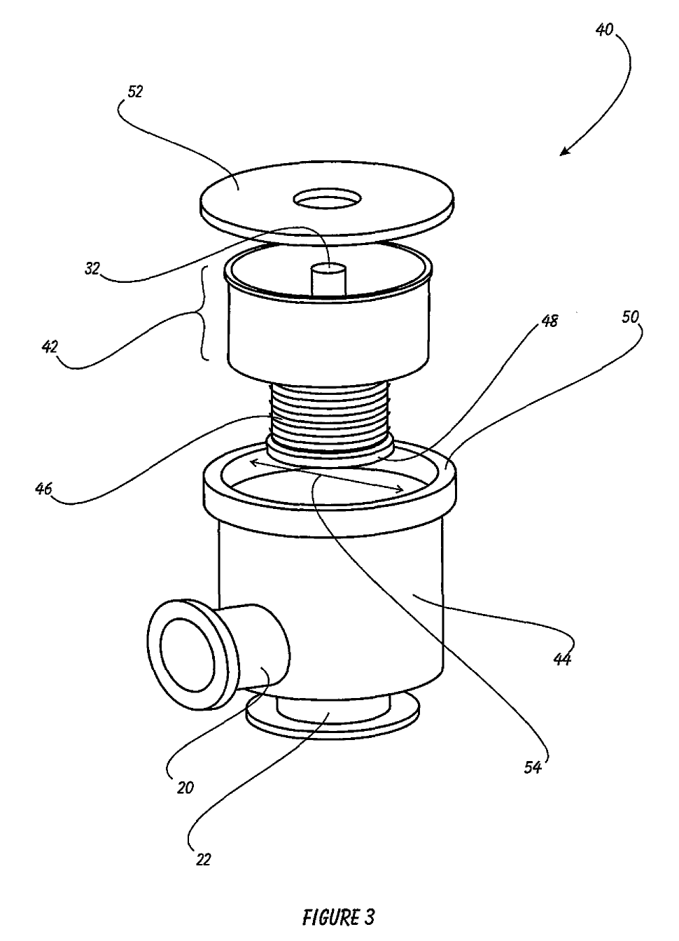

The present invention can best be understood by initial consideration of FIG. 3. FIG. 3 is a partially exploded perspective view of a preferred embodiment of the wide-body valve 40 having an internalized actuator of the present invention. The valve assembly 40 operates essentially the same as does the prior art valve discussed above, namely, that the valve is opened and closed by application and removal of control gas to a pneumatic valve actuator. Non-pneumatic actuators could also be utilized in the same arrangement discussed below. Also, springs can be used to create a “Home” position for the actuator.

The valve 40 comprises a valve body housing 44, which has an open top flange 50, to which a top cap 52 seals to enclose the valve body housing 44. What is unique here is that rather than the valve's actuator being located above/outside of the top cap 52, it is rather contained within the valve body housing 44 (i.e. under/within the top cap 52). The actuator assembly 42, as with the prior valve assembly, has a valve stem 32 that terminates in the poppet 48. The portion of the valve stem 32 that is below/external to the actuator assembly 42 is encapsulated within a bellows 46. What is unique is that the actuator assembly 42, bellows 46 and poppet 48 are all contained within the valve body housing 44.

The discovery that lead to this valve/actuator arrangement and geometry is that valve conductance could be optimized by increasing the relative size of the valve body internal diameter 54, as compared to the outer diameter of the poppet 48. For a defined outlet port 22 diameter (which loosely determines the poppet 48 diameter), a valve's conductance can be increased substantially by enclosing the poppet 48 within a valve body housing 44 that has a significantly larger internal diameter 54. Empirically, it has been determined that the minimum ratio at which beneficial conductance results are obtained is 1.8 (i.e. that the internal body diameter 54 is nearly twice the diameter of the poppet 48 and the port that it seals).

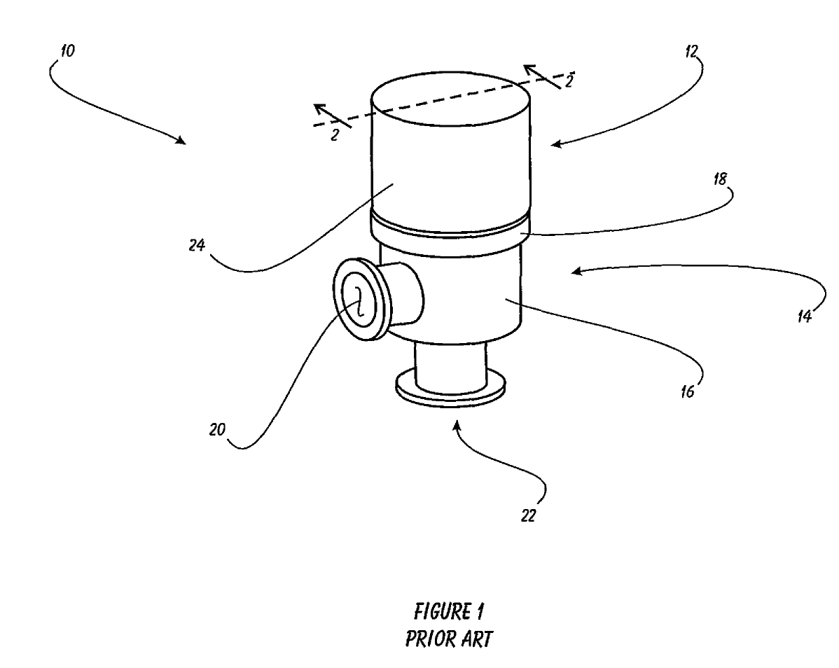

The relationship between body diameter and poppet/port diameter to valve conductance has allowed designers to more efficiently utilize a common valve design for manufacturability guidelines and thereby substantially reduce part count. The useable volume in the wide body concept allows the entire actuator to be fully contained within the internal volume of the valve body. This is a marked improvement over the volume required by the valve in FIG. 1.

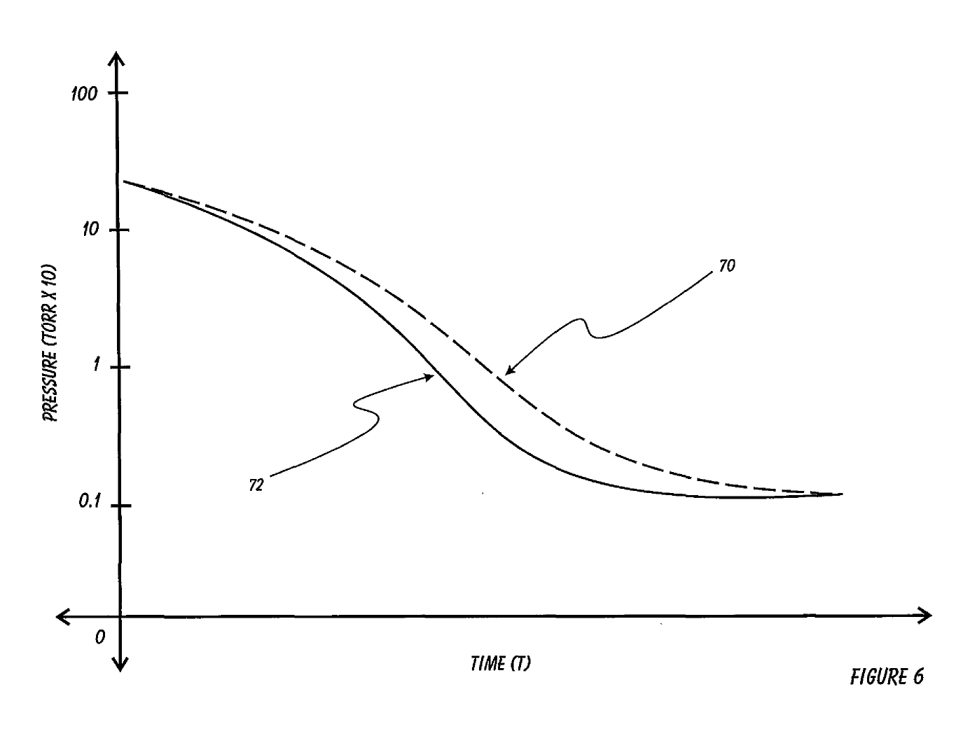

All testing was conducted on a valve with 1.5 inch diameter inlet and outlet ports 20, 22. It was discovered that the time required to evacuate a chamber of a given volume (110 liters) to a given pressure (5 Torr) is significantly affected by the diameter of the valve body 44 and the distance that the poppet 48 moves from the valve seat (i.e. valve stroke). The testing determined that there was a slight improvement in changing barrel diameter from 2.0 to 2.5 inches and then more significant changes when the diameter 54 was increased to 3.0 and then 3.5 inches. As mentioned above, it was resolved that the minimum effective ratio was approximately 1.8. The prior art valves, apparently in the interest of manufacturing efficiency (and most likely resulting from the built-in inaccuracies of common CFD programs), use a ratio of 1.3 or less. Additionally, the stroke of the valve played a significant role in evacuating the chamber. This effect reached diminishing returns at 30% or more of port diameter of stroke. The result is a valve that has a body to port diameter ratio greater than 1.8 and a stroke of 30% or more of port diameter. In addition to the performance improvements depicted in FIG. 6, this “nested” design drastically reduces the number of parts required for the assembly, and a smaller part volume.

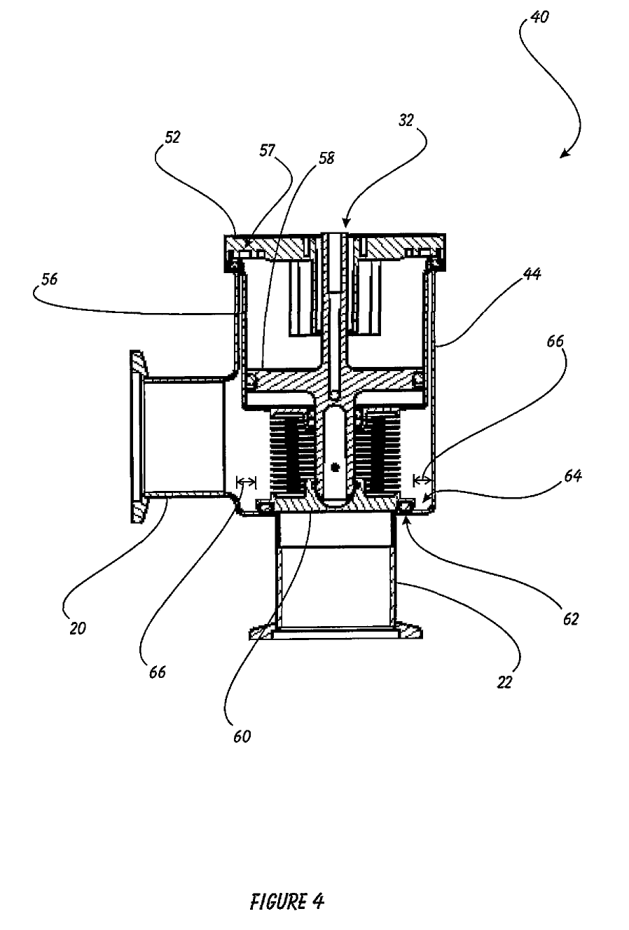

FIG. 4 is a cutaway side view of the device/assembly 40 of FIG. 3. When seen in its fully assembled form, the distinction from the prior art is clear. The entire valve and actuator assembly is contained within the body housing 44. The air piston 58 and upper portion of the valve stem 32 is contained within the actuator housing 56. The actuator housing 56 is fully covered by the top cap 52. The actuator seal 57 is pressed between the actuator housing 56 and the valve body housing 44 by the top cap 52 in order to seal the upper end of the valve body housing 44. Disassembly is a simple matter of removal of the top cap 52 and actuator assembly (contained within the housing 56).

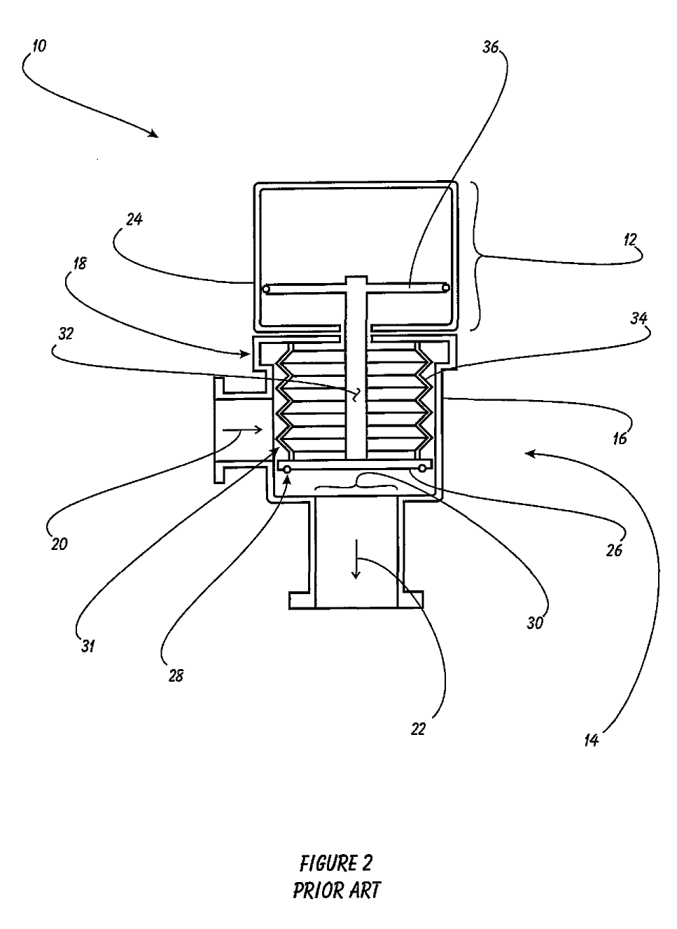

As discussed at length above, the design change that facilitated the internalization of the actuator is the ratio between the valve body housing diameter and the poppet 60. Of course, increasing this ratio results in a larger sidewall gap 66 between the outer perimeter of the poppet 60 and the inner wall of the housing 44. As can be seen in this depiction, the sidewall gap 66 is substantially greater than the (unlabeled) sidewall gap in valve of FIG. 2.

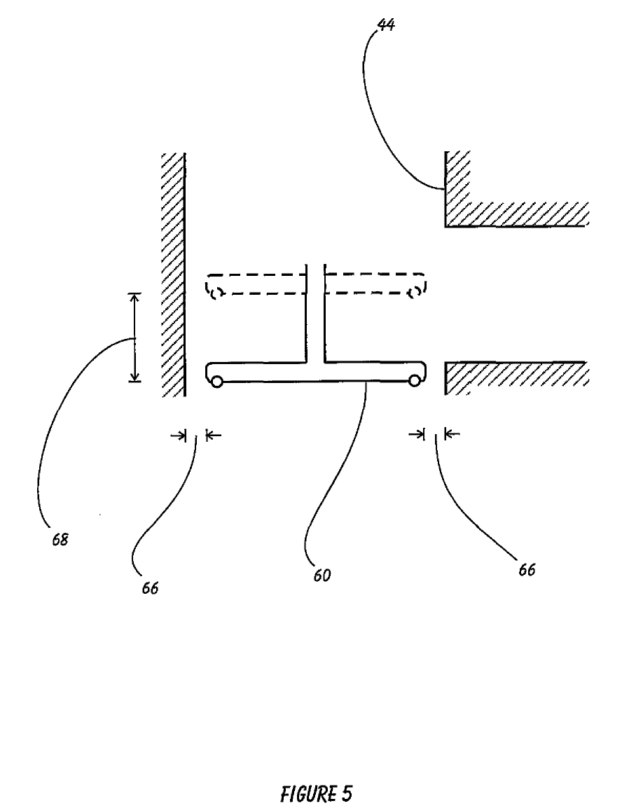

FIG. 5 addresses the issue of valve stroke. FIG. 5 is a partial cutaway side view of the poppet 60 geometry of the valve of FIGS. 4 and 5. The range of motion of the depicted valve is in excess of 30% or more of port diameter, which combines with the relationship of the body 44 diameter being greater than 1.8 times the diameter of the poppet 60, results in substantial conductance benefits, as depicted below in the chart of FIG. 6.

FIG. 6 depicts the performance comparison between the conventional valve of FIGS. 1 and 2 with the valve of FIGS. 3-5. The rate of decay of pressure curve for the conventional valve is depicted in dashed line and labeled as 70. The pressure curve for the valve depicted in FIGS. 3-5 is shown as a solid line and depicted as 72. While the long-range (low) pressure for the two curves is essentially identical, the valve of the present invention has a clear advantage over the prior art in terms of rate of reduction of pressure to a very low pressure state. This benefit is the direct result of observing the sidewall gap and valve stroke geometries discussed herein above.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A combination valve and actuator for said valve, comprising:
a valve body housing comprising:
a first port;
a second port;
a poppet actuatable by said actuator to seal one said port, said poppet residing within said valve body; and
said actuator encapsulated substantially within said valve body, said encapsulation accomplished by a top cap sealed to said valve body housing.

2. The combination of claim 1, wherein:
said valve body housing is defined by a sidewall having an internal diameter;
said poppet is defined by an outer diameter; and
said internal diameter being approximately twice the size of said outer diameter.

3. The combination of claim 2, wherein said internal diameter and said outer diameter cooperate such that a ratio of said internal diameter to said outer diameter is greater than or equal to 1.5.

4. The combination of claim 3, wherein said actuator comprises an actuator housing having an aperture formed therethrough and a valve stem extending through said aperture, said valve stem attached to said poppet at an area opposite to said actuator housing, wherein said actuator housing is encapsulated by said valve body housing and said top cap.

5. The combination of claim 4, further comprising a fluid piston extending from said valve stem, said fluid piston encased within said actuator housing.

6. The combination of claim 5, further comprising a diaphragm element interconnecting said poppet and said actuator housing to encase the portion of said valve stem extendable through said aperture in said actuator housing.

7. The combination of claim 6, wherein said poppet is further defined by a face, said face having a poppet seal disposed thereon, whereby said actuating of said poppet to seal said port causes said face to be driven until said poppet seal touches a valve seat formed in said valve body housing adjacently surrounding said port being sealed.

8. A pneumatically-actuated valve, comprising:
a pneumatically-powered actuator for driving a valve stem between a first and second position, said actuator substantially housed within an actuator housing;
a valve comprising a valve body housing, a port in fluid communication with an interior volume of said valve body housing, and a poppet within said housing, said poppet associated with said valve stem to selectively enable or disable said fluid communication; and
wherein said actuator housing is substantially contained within said interior volume of said valve body housing.

9. The valve of claim 8, wherein said actuator is defined by a top opening and said valve body housing is defined by a top opening, and both said top openings are sealed to encapsulate their respective housing internal volumes by a single top cap attached over both said top openings.

10. The valve of claim 9, further comprising an expandable bellows member interconnecting said poppet with said actuator housing such that there is no fluid communication between said valve body housing interior volume and an interior volume of said bellows member and said actuator housing.

11. The valve of claim 10, wherein said top cap is further defined by an aperture formed therethrough for accessing said valve stem.

12. A mechanically-actuated valve, comprising:
a powered actuator for driving a valve stem between a first and second position, said actuator substantially housed within an actuator housing;
a valve comprising a valve body housing, a port in fluid communication with an interior volume of said valve body housing, and a poppet within said housing, said poppet associated with said valve stem to selectively close or open said port; and
wherein said actuator housing is substantially contained within said interior volume of said valve body housing.

13. The valve of claim 12, having a valve stroke defined by the linear distance said valve stem travels between said first and second position, said valve stoke being in excess of one third of the diameter defined by said port.

14. The valve of claim 12, wherein said valve body housing defines an internal diameter and said poppet defines a peripheral diameter, said internal diameter being greater than or equal to 1.5 times said peripheral diameter.

15. The valve of claim 12, further comprising a fluid piston extending from said valve stem, said fluid piston encased within said actuator housing.

16. The valve of claim 12, further comprising a diaphragm element interconnecting said poppet and said actuator housing to encase the portion of said valve stem extendable through said aperture in said actuator housing.

17. The valve of claim 12, wherein said powered actuator comprises an actuator housing having an aperture formed therethrough and said valve stem extends through said aperture, said valve stem attached to said poppet at an area opposite to said actuator housing, wherein said actuator housing is encapsulated by said valve body housing and said top cap.

18. The valve of claim 12, wherein said actuator is defined by a top opening and said valve body housing is defined by a top opening, and both said top openings are sealed to encapsulate their respective housing internal volumes by a single top cap attached over both said top openings.

19. The valve of claim 12, further comprising an linearly-extendable bellows member interconnecting said poppet with said actuator housing such that there is no fluid communication between said valve body housing interior volume and an interior volume of said bellows member and said actuator housing.

20. The valve of claim 12, wherein said poppet is further defined by a face, said face having a poppet seal disposed thereon, whereby said actuating of said poppet to seal said port causes said face to be driven until said poppet seal touches a valve seat formed in said valve body housing adjacently surrounding said port being sealed.
